(19) United States
(12) Patent Application Publication
(10) Pub. No.: US 2010/0283576 A1
(43) Pub. Date: Nov. 11, 2010

(54) Key for A Lock Having An Open Architecture

(75) Inventors: John Loughlin, Lebanon, NJ (US); Robert Loughlin, Stanton, NJ (US)

Correspondence Address: DIEHL SERVILLA LLC, 33 WOOD AVE SOUTH, SECOND FLOOR, SUITE 210, ISELIN, NJ, 08830, US

(73) Assignee: Stanton Concepts Inc., Stanton, NJ (US)

(21) Appl. No.: 12/761,674

(22) Filed: Apr. 16, 2010

Related U.S. Application Data
(60) Provisional application No. 61/175,650, filed on May 5, 2009.

(51) Int. Cl. G05B 19/00; H04M 1/00; E05B 49/00

(52) U.S. Cl. 340/5.2; 455/556.2; 70/278.2

(57) ABSTRACT

An electronic key for opening a lock having a lock interface is disclosed. The key includes a housing, a key interface extending from the housing that can mate with the lock interface to move the key, a motor connected to the key interface for moving the key interface, a microprocessor circuit that includes a memory that controls the motor and a electronic communication port connected to the memory in the microprocessor circuit. New operating systems and applications or new versions thereof for the key can be downloaded to the memory through the electronic communication port, which can be wired or wireless. Alternatively, existing operating systems and applications can be modified through the electronic communications port. Methods of downloading operating systems and applications or versions thereof to the key are also disclosed.

### STATEMENT OF RELATED CASES

This application claims the benefit of U.S. Provisional Patent Application Ser. No. 61/175,650, filed May 5, 2009 which is hereby incorporated herein by reference in its entirety.

### BACKGROUND

“Security through obscurity” is not, and has never been, a sensible approach. With the internet providing open access, this strategy of providing security is clearly no longer achievable. Consider that a Google query on “lock picking” generates about 4,500,000 returns. There are about 10,000 videos on YouTube related to lock picking.

Many lock bypass methods have gained wide attention including bumping and shimming as well as more sophisticated attacks on “high security” locks. Additionally, lock picking has become a popular sport. For example; www.locksport.com has fourteen chapters in the United States and Canada, Lockpicking 101, having a web site at “www.lockpicking101.com” is a club with sixty thousand members. This site has a forum to discuss and collaborate on picking and bypass techniques.

The Open Organization Of Lock pickers (TOOOL) is based in The Netherlands and is the host and sponsor the annual Dutch Open lock picking competition. NDE (Non Destructive Entry), maintains a web site at “www.ndemag.com,” and is an on line periodical that caters to the lock sport community.

The lock sport community is composed predominantly of “white hats” that can play a vital role in the improvement of security hardware. These so-called “white hats” can offer great improvement to secure keys and locks. It is the general nature of security hardware manufactures to have their technology closed to outsiders. These security manufacturers are extremely adverse to people hacking their products and publishing any vulnerabilities, whether real or perceived.

Accordingly, new key and lock systems are needed to address these new realities in the security industry.

### SUMMARY

One aspect of the present invention provides a new viable key system to unlock locks that embraces the new reality described above. Another aspect of the present invention is to eliminate vulnerability issues and include state of the art auditing and intelligent access control features, and to facilitate continuous improvement by using the best available technology and encouraging peer review and collaboration.

In accordance with an aspect of the present invention, these results are achieved by providing an open architecture and by allowing certain elements of the new lock system to be open source.

In accordance with one aspect of the present invention, an electromechanical key for opening a lock having a lock interface is provided. The key can include a housing, a key interface extending from the housing that can mate with the lock interface to move the lock, a motor connected to the key interface for moving the key interface, a microprocessor circuit that includes a memory that controls the motor and an electronic communication port connected to the memory in the microprocessor circuit.

The electronic key of the present invention can provide wireless communication between the memory in the key and a device external from the key through the electronics communication port.

In accordance with another aspect of the present invention, a new operating system or a new version thereof for the microprocessor circuit can be downloaded through the electronic communication port to the memory in the microprocessor circuit. Alternatively, an existing operating system stored in the memory in the microprocessor circuit can be modified by communications provided through the electronic communication port to the memory.

In accordance with a further embodiment of the present invention, a new application for the microprocessor circuit can be downloaded through the electronic communication port to the memory in the microprocessor circuit. Alternatively, an existing application stored in the memory in the microprocessor circuit can be modified by communications provided through the electronic communication port to the memory.

The applications that are affected are selected from the group consisting of: an auditing application, an unlocking application, a locking application, and a user identification system. Other applications are also contemplated.

In accordance with another aspect of the present invention, a cradle for a portable computing device, such as a PDA or an iPhone® or iPAD® or other mobile device, is attached to the housing.

In accordance with a further aspect of the present invention, a key having a first housing and a second housing is provided. The first housing includes a key interface extending from the first housing that can mate with the lock interface to move the lock, a motor connected to the key interface for moving the key interface and a motor interface. The second housing includes a microprocessor circuit that includes a memory for controlling the motor, an electronic communication port connected to the memory in the microprocessor circuit and an interface that communicates with the motor interface in the first housing.

### DESCRIPTION OF THE DRAWINGS

FIG. 1 illustrates a key and a lock in accordance with one aspect of the present invention.

FIGS. 2A and 2B illustrate open views of one embodiment of a key in accordance with as aspect of the present invention.

FIG. 3 illustrates a block diagram of the circuitry of a key in accordance with an aspect of the present invention.

FIGS. 4 to 6 illustrate another aspect of the present invention.

FIG. 7 illustrates a further aspect of the present invention wherein a cradle for a portable computing device is provided on the housing of the present invention.

FIG. 8 illustrates another aspect of the present invention wherein the key is divided into to parts.

FIG. 9 illustrates a locking system is accordance with one or more aspects of the present invention.

### DETAILED DESCRIPTION

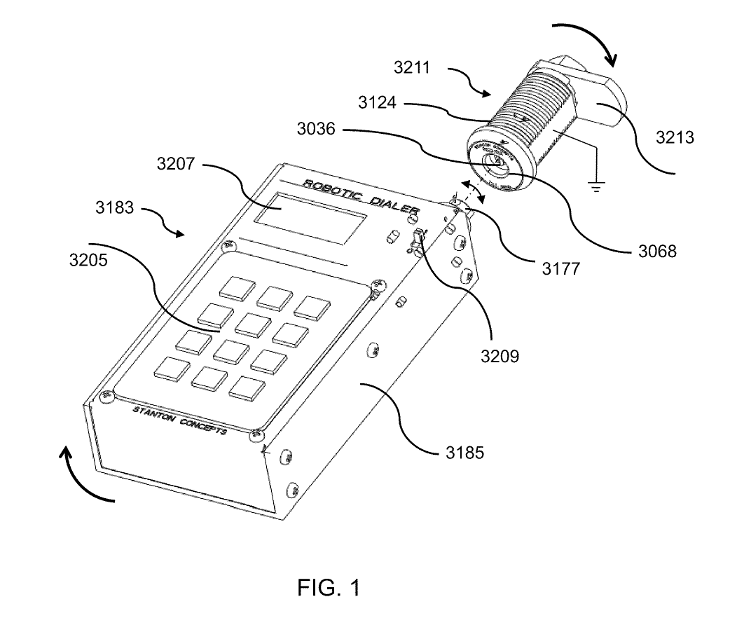

FIG. 1 illustrates an electronic key 3183 and a lock 3211 in accordance with one aspect of the present invention. The lock 3211 in accordance with a further aspect of the present invention is a combination lock of the tumbler wheel type. The electronic key is also referred to as a robotic dialer. The lock cylinder assembly 3211 is shown decoupled from the key 3183 for clarity. The dialer 3183 has a cover 3185, a keypad 3205, a LCD display 3207 and an on/off switch 3209.

The lock cylinder assembly 3211, in accordance with one aspect of the present invention, has a shell 3124 and a cylinder core assembly, an identifier and a cam latch 3213.

The keyboard 3205 on the electronic key 3183 can be used to enter PIN (Personal ID Numbers) to enable usage of the key, lock information, activation requests and other data. The LCD display 3207 could be used to display data and other textual or graphical data. The on/off switch 3209 turns the power off and on.

In one embodiment of the present invention, a lock 3211 can be un-locked by the following process, which is merely illustrative.

First, a user enters a PIN number into the keypad 3205. If the PIN is accepted, the user is prompted for a lock ID corresponding to the identifier associated with the lock 3211. The user enters the lock ID into the keypad 3205. If the ID is valid and the user is authorized to open that specific lock, a microprocessor circuit inside the key 3183 looks up the corresponding combination code for that lock 3211 and displays a message when ready; the user couples the lock interface or registration element 3177 of the key 3183 with the interface 3068 on the face 3036 of the lock 3211. A drive shaft of the key 3173 is coupled to a drive shaft of a drive wheel in the lock 3211. In one embodiment the drive shaft of the key 3173 couples to the dive shaft in a unique manner. This unique coupling of the drive shafts is, in a further embodiment, achieved by providing a notch in each of the drive shafts that can only mate in one unique manner to achieve coupling of the drive shafts. This unique mating of the drive shafts combined with the registration between key and lock provides the key with a calibrated starting position for opening the lock. The user then activates the key/dialer 3183 so that the microprocessor circuit provides dialing instructions to a motor controller in the key 3183, which controls the motor. A feedback loop controlled by an encoder enables the microprocessor circuit to continuously know the position of the drive shaft so that the drive shaft rotates in the correct clockwise/counter clockwise sequence. The drive shaft in the key 3183 rotates independently of the key body 3183 and the cylinder body 3211. At the completion of a successful dialing, the gates of the wheel pack in the lock 3211 are aligned with a side-bar to un-latch the cylinder lock assembly. The key 3183 is then rotated manually to rotate the cylinder core of the lock 3211 to unlock the lock.

This process is explained in co-pending U.S. patent application Ser. Nos. 11/255,659 filed on Oct. 21, 2005 and 11/186,698 filed on Jul. 21, 2005, both of which are fully incorporated herein by reference.

A record of the event is recorded in memory in the key/dialer 3183. It is anticipated that in addition to the motor dialing an accelerometer or other inclination sensor on the mother board could monitor and record the tool body rotation during un-latching and re-latching. The dialer or key could also be programmed to automatically scramble the wheel pack after re-latching. It could also be programmed to prompt the user to scramble the wheel pack.

The interface between the electronic key 3183 and the lock 3211 is a mating interface such that the key interface can mate with the lock interface so that the key interface can cause the lock interface to turn by, for example, rotation. The nature of the interface is not important for purposes of this invention, so long as the electronic key 3183 can cause the lock 3211 to rotate.

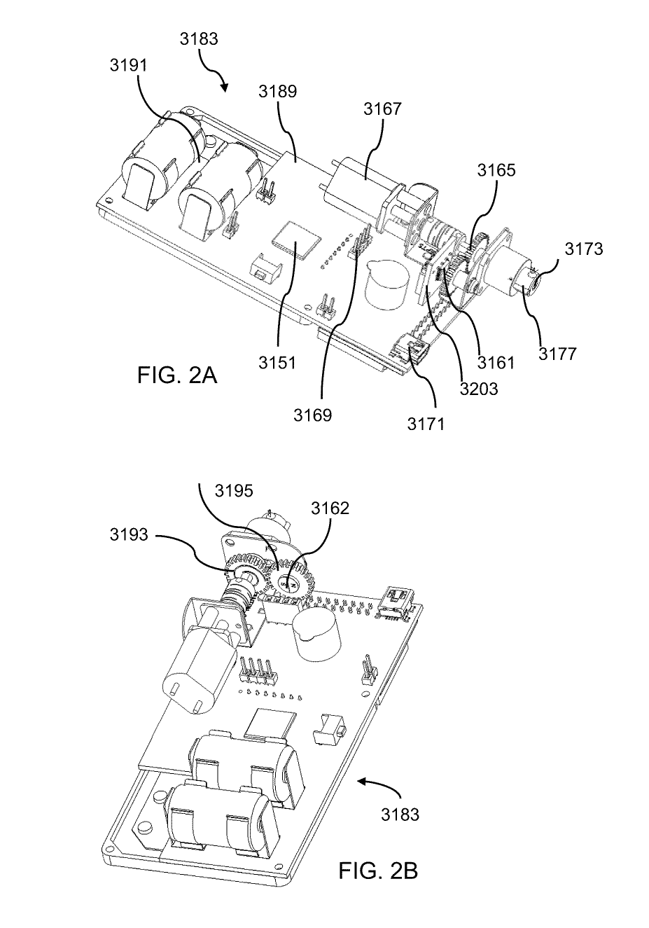

FIGS. 2A and 2B depict views of a physical embodiment of a key 3183 in accordance with one aspect of the present invention. A cover of the key 3183 is removed for clarity. FIG. 2A looks toward the front end of the key/dialer 3183. It shows a mother board 3189, a microprocessor 3151 having associated circuitry, program header 3169, a motor 3167, a rotary translation mechanism 3165, a rotary position encoder 3161, a drive shaft 3173, a registration or interface element 3177, a communication port 3171 and batteries 3191.

FIG. 2B is a view of the key/dialer 3183 looking from the rear. The rotary encoder 3161 is removed for clarity. FIG. 2B shows a bi-polar disc magnet 3162. In this embodiment the rotary translation mechanism is comprised of a two gear spur gears. One gear, the drive shaft gear 3193 is fixed to the drive shaft 3173. The second gear, the encoder gear 3195 is engaged with the drive shaft gear 3193 and spins upon an encoder gear post 3161. The disc magnet 3162 is fixed to the encoder gear 3195.

The embodiment in FIG. 2A depicts the drive shaft gear 3193 and the encoder gear 3195 having a gear ration of 1:1. The encoder gear 3195 rotates at the same rate as the drive shaft gear 3193 but in the opposite direction. It is anticipated that gears could be used to increase or decrease the ratio, depending on the desired position resolution of the encoder 3161. The two gears 3193 and 3195 used for the rotary translation mechanism 3165 in this embodiment are spur gears, it is anticipated that the mechanism could employ, miter gears, worm gears or the like. It is also anticipated that the spur gears could be anti-backlash gears.

The encoder 3161 and the encoder gear 3195 are parallel and co-axial. The encoder is shown as a connectorized daughter board 3203 in this embodiment. They are also normal to the mother board 3189 in this embodiment. Other gear arrangements could be used to so the encoder is parallel to the mother board. The encoder 3161 could be mounted directly to the mother board 3189.

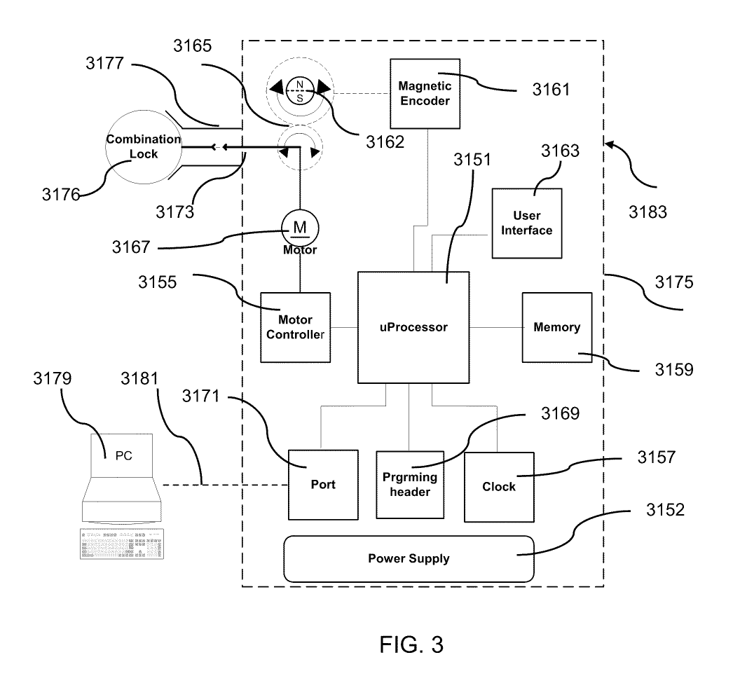

FIG. 3 is a functional block diagram of a key 3183 in accordance with one aspect of the present invention. FIG. 3 illustrates a microprocessor 3151, such as Microchip part number PIC16F9117TQFP, a power supply 3152, a motor controller 3155 such as Toshiba part numberTB6552FNG, a real time clock 3157 such as Dallas part number DS3231S, a memory device 3159 such as Microchip part number 24AA512-I/SM, a magnetic rotary position encoder 3161 such as Austria Micro Systems part number AS5030, a bi-polar disc magnet 3162, a rotary translation mechanism 3165, a motor, 3167, a programming header 3169, a bi-directional port 3171, a drive shaft 3173, a registration element, a user interface 3163, a RKS combination lock 3176, a PC 3179, a bi-directional communication link 3181 and a functional boundary box 3175.

The operating system for the microprocessor circuit 3151 is stored in the memory 3159. Also applications that operate on the microprocessor circuit 3151 are also stored in the memory 3159. The operating system is stored in a operating system section of the memory 3159 and the applications are stored in the application section of the memory 3159. The applications can include auditing applications, unlocking applications, locking applications and user identification applications as well as other applications.

The user interface 3163 can be a keypad or any other known user interface device.

In accordance with one aspect of the present invention, the program header 3169 facilitates downloading firmware code to the memory 3159 in the microprocessor circuit 3151. The memory device 3159 is used to store key/dialer events and other auditing information. The clock 3157 provides date and time data for the key/dialer activities. The memory device 3159 can also be used to store lock combinations and user data. The user interface 3163 can includes an LCD, switches, keypad, speaker, LEDs, a biometrics detector and other similar or different devices. The motor controller 3155 controls the motor 3167. The motor control algorithm can, in accordance with one aspect of the present invention, be included in the downloaded firmware. The rotary translation mechanism 3165 couples the rotational output of the motor 3167 to the bi-polar disc magnet 3162. The rotary position magnetic encoder 3161 senses the angular position of the motor drive shaft to provide a position control loop with the microprocessor. The output drive shaft 3173 is uniquely coupled to the lock's 3177 drive wheel. The registration or interface element 3177 uniquely engages with the lock's mating interface.

In accordance with one embodiment of the present invention, a record of an unlocking event or an attempt to unlock by the key/dialer is recorded and stored in the memory device 3159. A PC, MAC, PDA or similar or other computing device can be connected to the communication port 3171 of the key/dialer to retrieve the activity data. These devices can be located in a central control system. The communication link 3181 is a wired, wireless, radio frequency or infrared connection or any other communication link for transmitting data signals. Management software could be installed on the PC or like device to download passwords, access control, lock combinations or other data or applications to the key/dialer.

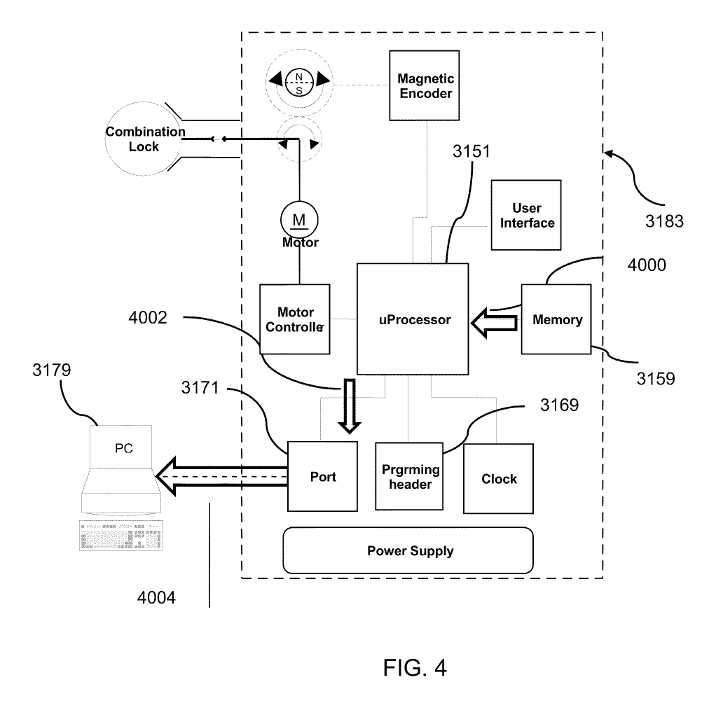

FIG. 4 illustrates a key 3183 with information being downloaded from the key to an external device in accordance with an aspect of the present invention. The external device 3179 is a personal computer or the like. The information is audit information, generally relating to an unlocking event or an attempt to unlock by the key 3183. The information will generally include the time of the event, the lock identity, the user of the key, the authorized users of the key, the length of time the lock was engaged, whether the attempt was successful and other related information.

Referring to FIG. 4, when the PC 3179 is connected to the port 3171, an instruction from the PC 3179 is delivered to the microprocessor 3151. The microprocessor 3151 interprets the instruction to determine what information is being requested by the PC 3179. Based on the request, the microprocessor 3151 requests the information from the memory 3169. As shown by arrow 4000, the requested information is passed from the memory 3169 to the microprocessor 3151. As shown by arrow 4002, the requested information is then passed by the microprocessor 3151 to the port 3171. Then, as shown by arrow 4004, the requested information is passed by the port 3171 to the PC 3179. Thus, the PC 3179 can monitor and audit the activity of the key 3183.

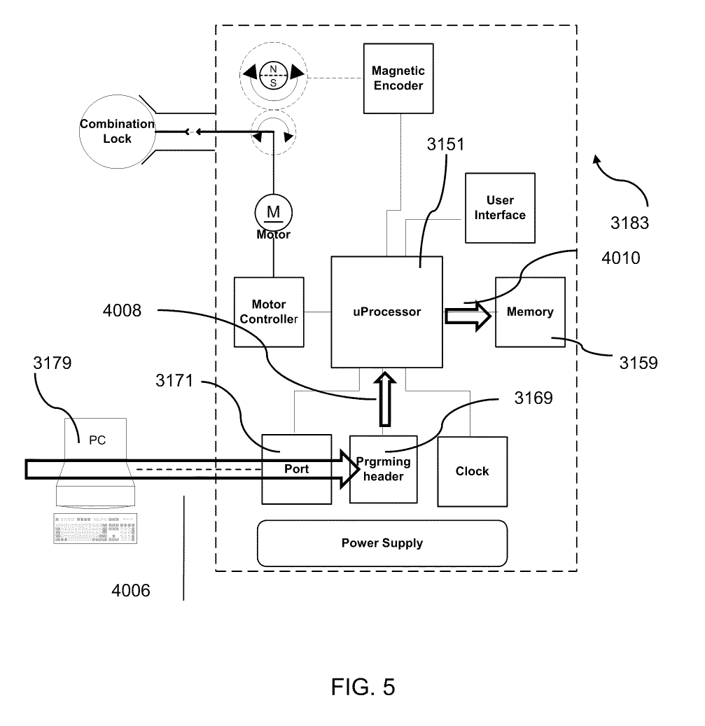

FIG. 5 illustrates a key 3183 with information being downloaded from an external device to the key 3183 in accordance with an aspect of the present invention. The external device 3179 is a personal computer or the like. The information can be an operating system for the microprocessor 3151, a modification to the operating system, new applications for the key or modifications to the existing application. The programming header 3169 is typically a multi-pronged post or connector on a circuit to which a cable is connected, thereby connecting the PC 3179 to the key 3183. Instead of a wired connection also a wireless connection can be used to provide programming data. In one embodiment the programming header 3169 is a wireless communication device that can at least receive data in a wirelessly provided signal.

Referring to FIG. 4, when the PC 3179 is connected to the programming header 3169, an instruction from the PC 3179 is delivered to the microprocessor 3151. The microprocessor 3151 interprets the instruction to determine what information is being loaded to the key 3183 by the PC 3179. Based on the request, the microprocessor 3151 directs the information—typically operating system information or application information—to the memory 3169. As shown by arrow 4006, the PC 3179 sends an instruction regarding the type of information being loaded followed by the information to the programming header 3169. The microprocessor 3151 receives the information, as indicated by arrow 4008. After the microprocessor 3151 interprets the instruction from the PC 3179, the microprocessor causes the information to be stored in the appropriate location in memory 3159, as indicated by arrow 4010.

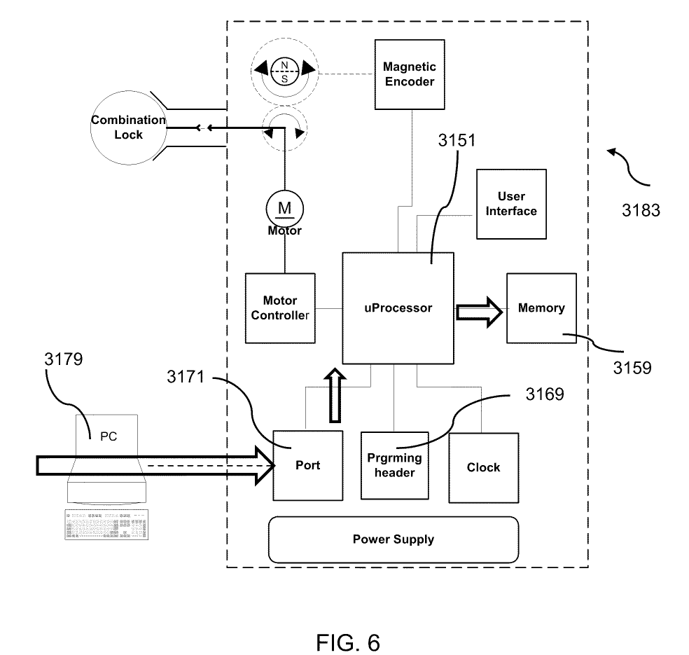

The same transfer of information can be accomplished using the port 3171 instead of the programming header 3169, as shown in FIG. 6. In this case, the microprocessor 3151 is programmed to receive operating system information and application information from the port 3171.

Information such as motor control algorithms, user identification information including biometrics, lock identities, allowed unlocking times, schedules, all of the information described herein and the like can be communicated in the fashion described herein. This information is typically contained in various applications that are downloaded. As discussed before, operation systems for the microprocessor 3151 can be downloaded in any manner described herein.

The present invention also includes open sourcing concepts. Open sourcing is becoming increasingly common in software including IT-security software. Some of the more prominent products include the Linux operating system, the Apache web server and the Firefox web browser. The Open Source Software Initiative (OSI) is a non-profit organization that is actively involved in the open source community, their goal is to build and educate the community and meet with the public and private sectors to promote and discuss how Open Source Software technologies, licenses and development approaches can provide economic and strategic advantages. Accordingly, in accordance with an aspect of the present invention, the operating system for the microprocessor circuit 3151 is a Linux operating system.

The electronic communications port 3171 and the programming header 3169 can be provided as a single port, if desired. The communications provided to the key 3183 would, in that case, preferably specify what type of communication was being provided. For example, the communications could specify that a new operating system was being downloaded, that an existing communication system was being modified, that a new application was being downloaded or that an existing application was being modified. The microprocessor 3151 would read the communication header where this information is stored and determine the appropriate locations in memory 3159 to overwrite.

Further, the electronic communication port can be wireless port as well as a wired port.

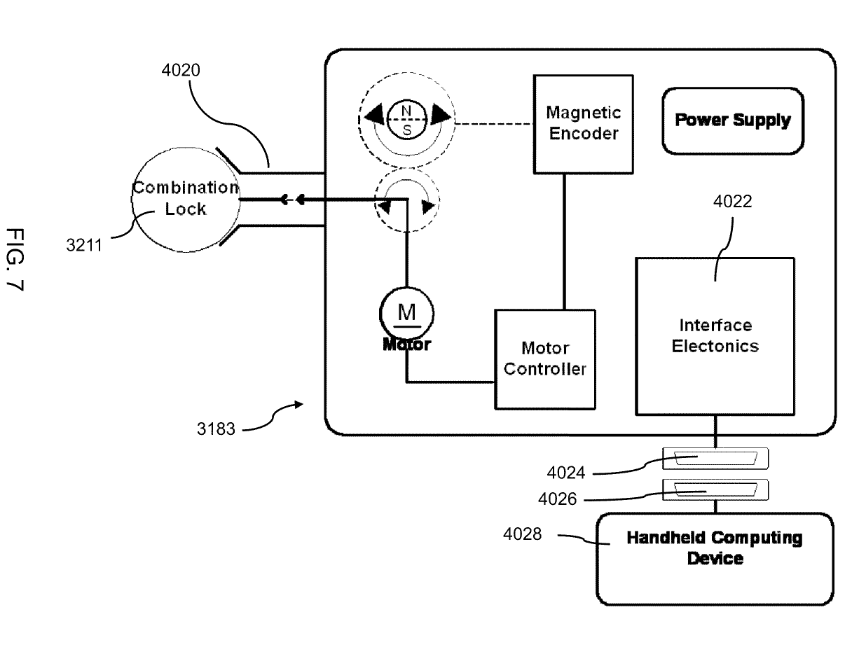

FIG. 7 illustrates a further aspect of the present invention. In FIG. 7, a key/dialer 3183 is connected to a combination lock 3211 through their respective mating surfaces 4020 so that the key/dialer 3183 can rotate the mechanisms in the combination lock 3211 to place the lock 3211 in an unlocked position. In accordance with an aspect of the invention, interface electronics 4022 interfaces with connectors 4024 and 4026 and provides control of the operation of the key 3183. Connectors 4024 and 4026 connect with each other. Connectors 4024 and 4026 may be embedded connectors that are part of device 3183 and 4028 respectively. A connector may also be a separate connector such as a cradle. For instance 4024 may be a connector with at least two interfaces, that with a first interface connects to electronics 4022 in the dialer/key 3183 and that with a second interface connects to an interface of connector 4026. Connector 4026 may be a connector with at least two interfaces, that with a first interface connects to handheld computing device 4028 and that with a second interface connects to the second interface of connector 4024. Connectors 4024 and 4026 thus can connect dialer/key 3183 with external computing device 4028. A connector may be implemented as a cradle that is enabled to physically receive a device and electronically interface to that device. The two connectors may also be implemented as a first cradle and a second cradle to cradle both the key/dialer and the handheld computing device. In a further embodiment the first and second cradle may be integrated into a single combined cradle. One of the cradles, for example, cradle with connector 4026, is preferably adapted to receive a portable computing device 4028. The portable computing device is preferably a mobile computing device, such as a PDA, a cell phone or an iPhone® or iPAD®.

In one embodiment the key dialer 3183 and external computing device 4028 do not have a cradle but are connected to communicate via communication interfaces 4024 and 4026. In another embodiment the interfaces 4024 and 4026 are wired interfaces such as fixed metal connectors. In yet another embodiment the interfaces 4024 and 4026 are wireless interfaces such as radio interfaces or optical interfaces.

The portable computing device, such as the iPhone® or iPAD®, can store new operating systems, modifications to existing operation systems already stored in the interface electronics 4022, new applications, and modifications to existing applications already stored in the interface electronics 4022. The portable computing device, such as the iPhone® or iPAD®, can control the downloading of this information to the interface electronics 4022 so that the operation of the key 3183 can be varied.

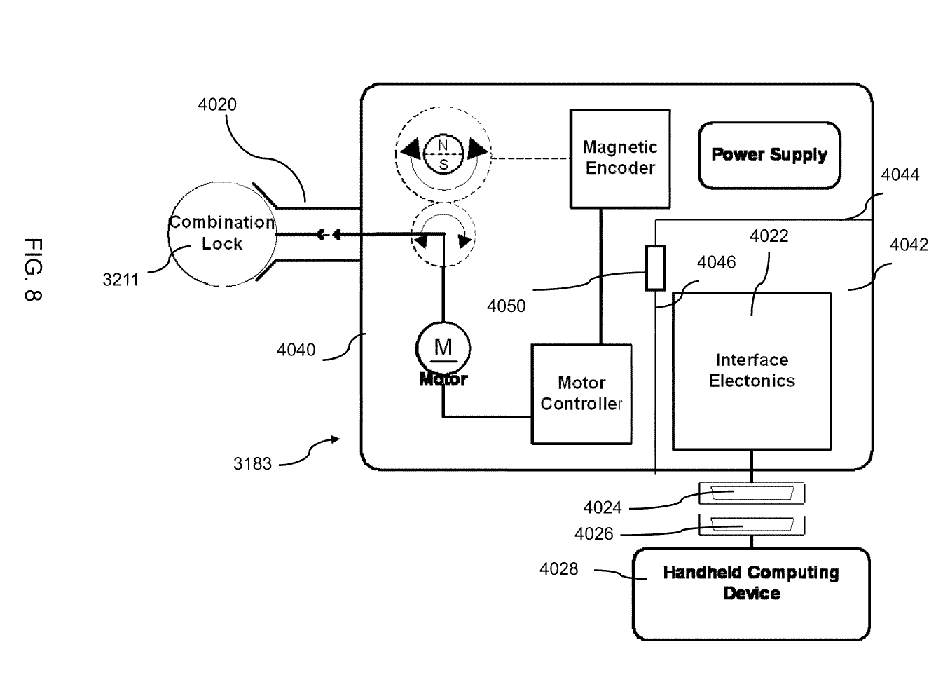

FIG. 8 illustrates another aspect of the present invention. The key 3183 is split into two parts 4040 and 4042, preferably along lines 4044 and 4046. Two separate housings are provided. In the first housing 4040, the engaging, drive and main power elements are provided. In the second housing 4042, the security functions, including management, control, audit trails and others are provided. Thus, the interface element which includes the microprocessor circuit and the interface connectors are provided in the second housing. Each of the first housing 4040 and the second housing 4042 are provided with a connector or interface, shown connected in FIG. 8 as 4050. The microprocessor circuit in the second housing 4042 provides control signals through the connectors 4050 to the motor to control the motor and to unlock a lock.

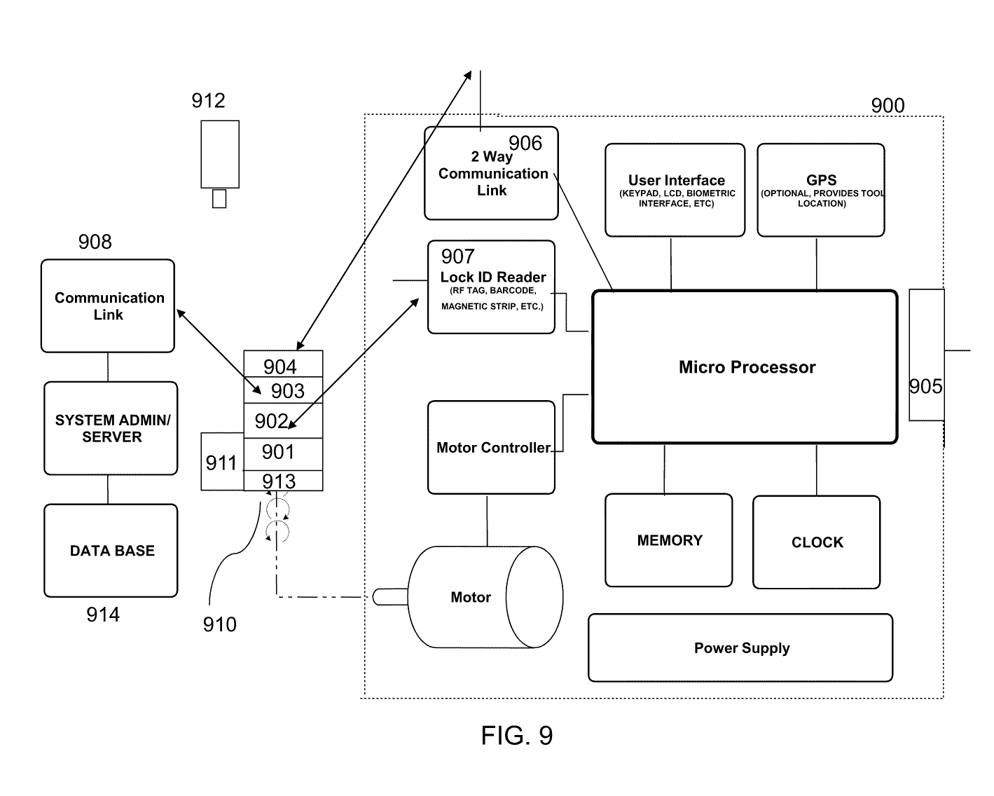

In one embodiment a combination lock is provided with a communication circuit. This is illustrated in FIG. 9 which shows a dialer/key 900 and a combination lock 901 which is part of a housing 910. The housing further contains in one embodiment a communication device 902 that can communicate with a lock ID reader 907. For instance, 902 may be a wireless device such as a RFID device that communicates identifying lock data to the dialer/key ID reader 907. It is to be understood that in another embodiment the ID reader reads passive data, such as a bar code pattern from the lock and the device 907 in such an embodiment may be a bar code reader.

In another embodiment the housing 910 may contain a memory enabled to store instructions and data and a microprocessor 911 to process data and execute the instructions. The housing 910 in yet a further embodiment contains a communication device 904 that is enabled to communicate in one-way or two-way mode, preferably wireles sly, with a communication device 906 in dialer/key 900. The microprocessor 911 may be programmed to only allow opening of the lock 901 with the dialer/key when an authorized user is identified. Such authorization may be provided by a user of a key through an interface for instance in the form of a code or biometric information which is in processed or unprocessed form provided in one embodiment by the device 906 in the key dialer to the communication device 904 in the lock housing. This data is then in one embodiment provided to the microprocessor 911.

In a further embodiment the microprocessor checks the data against internally stored data to check if the user is authorized. If the user is authorized, the microprocessor may initiate the release of an internal lock 913 that blocks the combination lock 901 from being opened. Such an internal lock may be a bolt that prevents a driving wheel in the combination lock from being rotated, thus preventing opening of the combination lock. The internal lock may also prevent a side bar from being lowered in aligned gates in the combination lock, thus also preventing opening of the combination lock. Other internal blocking mechanisms that can be disabled are fully contemplated. Accordingly, a signal preferably provided by the microprocessor but which may also provided by another source, has to be provided in this embodiment to allow a key/dialer 900 to open the combination lock 901.

In one embodiment the lock housing communicates with the outside world, not including the key/dialer 900, through a communication device 903 with a communication link 908. The communication device 903 may be a wireless device; it may also be a wired device. The communication link 908 in one embodiment connects to a network to connect to a server and/or a database. The communication link may connect to a private network. It may also connect to a public network. The communication link 908 in one embodiment connects to the Internet. For instance, in one embodiment the communication link 908 is a Wi-Fi connection link. The external connection link 908 can connect to a database 914 in one embodiment to allow the processor 911 to obtain permission from the database or an external authority to allow the lock to be prepared for opening by the processor 911. The processor 911 provides information to 914 related to a user of 900 or about properties of 900. Based on the analysis of this data the processor 911 may receive data via 908 to 903 to allow opening of the lock 901. In one embodiment the key/dialer may provide an internal ID number via 906 to 904. The processor 911 may forward this information via 903 to 908 to database 914 which may check if this is an authorized key/dialer. The data provided to the database may also include GPS data of the position of the key/dialer. The database may check if the GPS position of the key/dialer is substantially the same as of the lock.

In another embodiment, a server that receives data from the lock through for instance link 908 instructs a device 912 to start operating. The device 912 is, for instance, a video camera that is located on site of the lock to record images of a person trying to open the lock.

As discussed earlier, the key/dialer 900 may be provided with an interface 905 to connect to a computing device such as a mobile phone. The computing device can also connect to the lock, for instance via the Internet. In that situation the computing device can instruct the database or the server to provide data via 908 to the microprocessor 911. The computing device can also provide instructions to the key/dialer. The computing device can also review data, including images, related to the lock and/or the key dialer. For instance a time stamp may be created when someone tries to open the lock. This may further include ID data, if the opening was successful, if authorization was requested, if image data is available, etc.

The above connections and connecting devices may all exist together in one embodiment. Also only one or more, but not all connections and/or connecting devices may be available and/or implemented.

The configuration as illustrated in FIG. 9, allows the programming or change of program of the microprocessor of the key/dialer and the programming or change of program of the microprocessor in the lock housing. Collaboration between lock and key/dialer can be achieved. One can remotely instruct the lock, for instance via the computing device via the Internet to deny access to a key/dialer with a certain ID. One may also provide the dialer with the combination of the lock in case of an emergency.

The different embodiments provided herein offer many different opportunities to program the key/dialer, the lock and to enable devices related to the lock and/or dialer. In one embodiment the system, comprised of the key/dialer with one or more communication interfaces is provided. These interfaces may communicate for instance with a computing device, with a lock, with a network such as the Internet, or with a mobile computing device such as a cell phone. The lock may also have one or more communication devices enabled to communicate for instance with a key/dialer, with a computing device such as a cell phone, and with a network such as the Internet or any other network. A system in one embodiment contains a database and a network server connected to a network and being enabled to exchange data with a lock, a key/dialer, a computing device such as a cell phone related to a lock and/or a key dialer and an electronic device that can be enabled by a signal from the database and/or the server. The processors of the key/dialer and/or the lock can be programmable by external signals. In one embodiment the processors can be provided with a program that is uploaded from a computing device or a server. For instance the processors may run an operating system such as Linux that can execute application programs. Such application programs may be developed in a publicly available development kit. Such a development kit may include a computer language such as Ruby and a tool to create a microprocessor executable.

In one embodiment a lock is enabled to receive or transmit data when the lock has been opened by the key/dialer. This may apply to certain types of data, for instance to program data. In that case a lock can for instance only be programmed or reprogrammed when it is in an opened condition. Other data exchange may also depend on the ‘open’ status of the lock. The ‘open’ status of a lock may be determined in one or more ways. For instance, in an ‘open’ status, a latch of the lock is in ‘open’ position, which may generate or enable an ‘open’ signal. In an ‘unlocked’ situation, a sidebar inside a combination lock is dropped into wheel gates, which may ‘make’ or ‘break’ a signal path and generate a ‘lock open’ status acknowledgement. Other lock ‘open’ detection and acknowledgements are possible and contemplated. Such an acknowledgement signal can be created in a mechanical, electromechanical, electric, optical or other manner.

The availability of a programmable lock system, tools to develop programs and communication devices to load the programs on the lock system enables a developer to develop a specific program for the lock system and to allow a user to implement a program on a system. Such programs may be posted on a database that is connected to a network such as the Internet. An owner or operator of a locking system may search the database for desirable applications and download these applications for implementation on the lock, the key/dialer and/or a computing device such as a cell phone. In a further embodiment the database of applications is managed by an authority that manages the quality and security of the applications.

The present invention also includes a method for communicating with a key. In accordance with one aspect of the method, a central control system or other system wirelessly transmits software to the key. The key receives the software with a wireless communication circuit in the key. A wired communication circuit can also be used and the software can be transmitted via a wired connection. Once the key receives the software, it is stored in memory in the key so that a processor circuit in the key can use the software.

The software can be an operating system for the processor circuit in the key. It can also be an application for use by the processor circuit. The application can be selected from the group consisting of: an auditing application, an unlocking application, a locking application, and a user identification system.

In accordance with further aspects of the present invention, the processor circuit then controls a motor in the key to unlock a lock. The key operates in the manner previously described during the unlocking process. The key can operate in accordance with the operating software or the application that was downloaded into memory in the key.

Data as disclosed herein to provide lock opening data, authorization data, programming data and computer application and operating system data and all other data that can be received and/or transmitted by the key/dialer and/or the lock can be encrypted data. It can also be ‘clear text’ data. In one embodiment, encrypted data can be generated in the key/dialer and/or lock by an encryption program, for instance running on a microprocessor in the key/dialer and/or the lock. In another embodiment, received encrypted data can be decrypted by a program that runs on a microprocessor on a microprocessor in the key/dialer and/or the lock. This allows a lock and its corresponding key/dialer to be operated in a secure manner. An encryption in a further embodiment changes dynamically. These changes happen for instance as a function of time or a function of times of access. Even if a malfeasant ‘steals’ a signal, it cannot be used a second time as its encryption key may have changed.

The invention has been described with specific reference to the embodiments and modifications thereto described above. It is to be understood that the invention is not limited to the details of construction or process steps set forth in the following description. The invention is capable of other embodiments and of being practiced in various ways. Further modifications and alterations may occur to others upon reading and understanding the specification. It is intended to include all such modifications and alterations insofar as they come within the scope of the invention.

1. A key for opening a lock having a combination lock interface comprising:
a housing;
a key interface extending from the housing that can mate with the lock interface to move the combination lock;
a motor in the housing connected to the key interface for moving the key interface;
a processor circuit in the housing that includes a memory, the microprocessor circuit controlling the motor; and
an electronic communication port mounted to the housing and connected to the memory.

2. The key of claim 1, wherein the electronic communication port includes a wireless communication circuit.

3. The key of claim 1, wherein the electronic communication port includes a wired communication circuit.

4. The key of claim 1, wherein the processor and the memory are configured so that a new operating system or a new version of the operating system for the microprocessor circuit can be downloaded into the memory through the electronic communication port.

5. The key of claim 1, wherein an operating system stored in the memory can be modified by communications provided through the electronic communication port.

6. The key of claim 2, wherein an operating system stored in the memory can be modified by communications provided through the electronic communication port.

7. The key of claim 1, wherein the processor circuit and the memory are configured so that a new application for the processor circuit can be downloaded through the electronic communication port to the memory in the microprocessor circuit.

8. The key of claim 2, wherein the processor circuit and the memory are configured so that an application stored in the memory can be modified by communications provided through the electronic communication port.

9. The key of claim 7, wherein the processor circuit and the memory are configured so that an application system stored in the memory can be modified by communications provided through the electronic communication port.

10. The key of claim 7, wherein the new application is selected from the group consisting of: an auditing application, an unlocking application, a locking application, and a user identification system.

11. The key of claim 9, wherein the application is selected from the group consisting of: an auditing application, an unlocking application, a locking application, and a user identification system.

12. The key of claim 1, wherein information relating to attempts to unlock locks by the key is stored in the memory and that information can be communicated through the electronic communication port.

13. The key of claim 1, further comprising a cradle for a portable communication device, the cradle having a communication path to the processor circuit.

14. The key of claim 13, wherein the portable communication device is a PDA.

15. The key of claim 13, wherein the portable communication device is an iPhone® or iPAD®.

16. The key of claim 1, further comprising a wireless communication device to exchange data with a wireless communication device in a portable computing device, the wireless communication device in the key having a communication path to the processor circuit.

17. A key for opening a lock having a lock interface comprising:
a first housing comprising;
a key interface extending from the first housing that can mate with the lock interface to move the lock;
a motor connected to the key interface for moving the key interface; and
a motor interface for providing control signals to the motor;
a second housing comprising:
a microprocessor circuit that includes a memory, the microprocessor circuit able to control the motor;
an electronic communication port connected to the second housing connected to the memory in the microprocessor circuit; and
a microprocessor interface connected to the motor interface wherein control signals from the microprocessor circuit in the second housing are provided to the motor in the first housing.

18. A method for communicating with a key comprising:
wirelessly transmitting software to the key;
receiving the software with a wireless communication circuit in the key;
storing the software in memory in the key so that a processor circuit in the key can use the software.

19. The method of claim 18, wherein the software is an operating system for the processor circuit in the key.

20. The method of claim 18, wherein the software is an application for the processor circuit in the key.

21. The method of claim 20, wherein the application is selected from the group consisting of: an auditing application, an unlocking application, a locking application, and a user identification system.

22. The method of claim 18, comprising the processor circuit controlling a motor in the key to unlock a lock.
